(19) United States
(12) Patent Application Publication
(10) Pub. No.: US 2013/0126439 A1
(43) Pub. Date: May 23, 2013

(54) SYSTEM AND METHOD OF SEPARATING PRODUCT FROM SLUDGE IN STORAGE TANKS

(71) Applicants: Yehezkel Samy Ezair, Haifa (IL); Daniel Berman, Tel Aviv (IL)

(72) Inventors: Yehezkel Samy Ezair, Haifa (IL); Daniel Berman, Tel Aviv (IL)

(21) Appl. No.: 13/813,957

(22) PCT Filed: Aug. 8, 2011
(86) PCT No.: PCT/IL11/00642

§ 371 Date: Feb. 4, 2013

(30) Foreign Application Priority Data
Aug. 19, 2010 (IL) 207717

(51) Int. Cl. C02F 11/00

(52) U.S. Cl. CPC C02F 11/00
USPC 210/737; 210/172.1

(57) ABSTRACT

A system and method of removing product from sludge at a bottom of a storage tank that includes introducing a liquid to the tank, heating and agitating the liquid to separate the product from the sludge, and then removing the separated product and removing the introduced liquid.

### FIELD OF THE INVENTION

The invention relates to storage tanks such as those used to store fuels and chemicals at industrial facilities.

### BACKGROUND OF THE INVENTION

Above ground storage tanks (AST) and underground storage tanks (UST) may store or contain, crude oils, fuels or other chemicals and substances at industrial facilities such as airports, refineries, depots, factories etc. Such tanks may be filled and drawn down numerous times over extended periods before they must be cleaned out from residues, sediment, sludge and other deposits that may accumulate at their bottoms. Frequently, portions of the product or substance that had been stored in the tank may adhere to the sludge, and the sludge may contain large quantities of the product that may add to the volume and weight of the sludge that is to be removed and treated when the tank is cleaned. Such increased volume and weight may add to the expense of removal, treatment or disposal of the sludge. Further, the congealed product that is mixed with the sludge may reduce the viscosity of the sludge making the sludge harder to remove.

### SUMMARY OF THE INVENTION

In some embodiments a method of the invention may involve separating a substance from sludge collected in a tank during a period of storage of the substance in the tank by adding a liquid to the tank, agitating the liquid in the tank above a level of the sludge, heating the liquid to a pre-defined temperature, and removing the substance that floats to the top of the liquid where it may be suspended once it has been separated from the sludge. The agitation process may continue for from several hours to several days. The agitation may involve generating a circular motion of the liquid in the tank, by for example adding the liquid from a pipe into which the liquid is pumped in the direction of the rotation. In some embodiments, the liquid may be heated to a temperature of above approximately 70 degrees Celsius. Increased levels of orthosilicic acid may be achieved by using partially distillated water to serve as the liquid. Once the process is completed or at another time, the liquid may be re-used and pumped to another tank while its heat or temperature is retained. The volume of the liquid added to the tank may be sufficient to raise the level of the suspended product to a level of a drain pipe through which the product may be pumped to a collection vessel.

The pump, heater and other equipment for the process may be combined into a moveable system that may be installed into and the removed from one or more tanks.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may be understood by reference to the following detailed description when read with the accompanying drawings in which:

FIG. 1 is a schematic representation of a tank having an installed separation system in accordance with an embodiment of the invention; and

FIG. 2 is a flow diagram of a method in accordance with an embodiment of the invention.

### DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention. It is to be understood that the phraseology and terminology employed herein is for the purpose of description and should not be regarded as limiting.

As used in this application and in addition to its regular meaning, the term ‘agitate’ may mean to circulate, rotate, mix, pump, or any other action that physically moves a liquid within one or containers. For example, agitate may include a process of pumping a liquid into a container and draining the liquid from the container in for example a continuous or intermittent process. Agitate may also mean operation of a propeller, mixer, aerator or other such installation in the container wherein the liquid is kept so that the liquid is kept moving within the container.

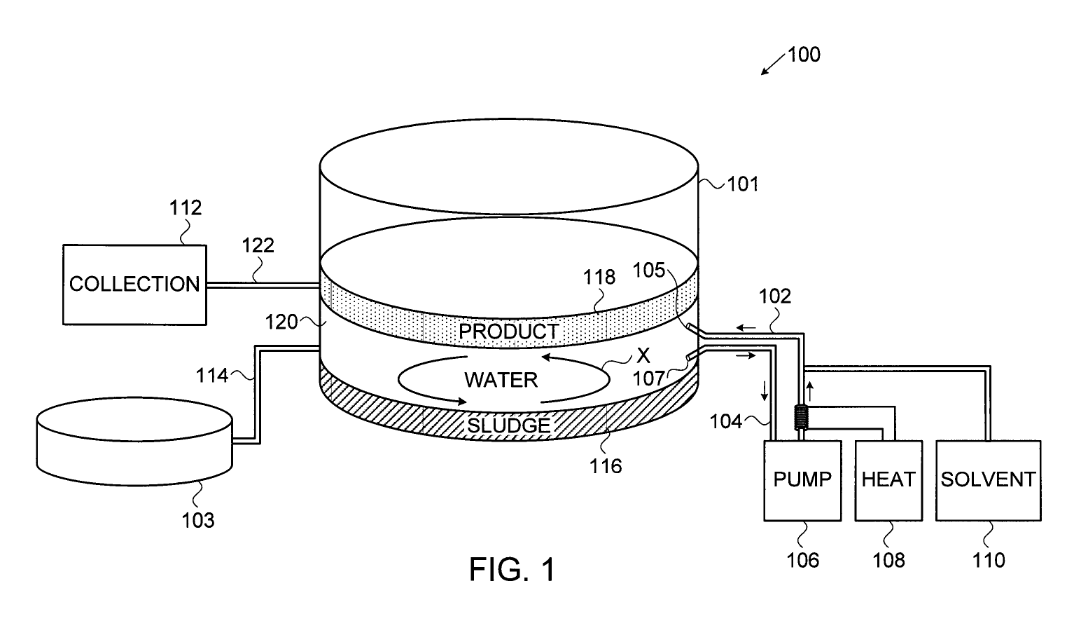

Reference is made to FIG. 1, a schematic representation of a tank such as an AST or UST having installed thereon a separation system in accordance with an embodiment of the invention. In some embodiments, a system 100 may include one or more pressure or input pipes 102 and suction or drain pipes 104 that may be connected to a tank 101 through for example a hole or series of holes in a wall of the tank 101. System 100 may also include a pump 106, a heating unit 108, and an additive unit 110 that may be connected to one or more input flows or to other points in the system 100. One or both of input pipe 102 and drain pipe 104 may include a curved or other shape end 105 and 107 that may extend into a cavity of tank 101 at an angle to an external wall of tank 101. In some embodiments, system 100 may include a collection unit 112 that may collect materials such as product or substances that are separated out from sludge in the tank 101. Some embodiments may include pipes or connection vessels 114 that may connect one tank 101 to another tank 103 or to other units, containers or processing vessels.

In some embodiments, there may have settled at a bottom or other area of tank 101 a layer of settlement, refuse, other materials or sludge 116, where such sludge 116 may include dirt, sand, rocks, decayed materials or other particles and in which may be mixed or adhered parts of product 118 that had been stored in tank 101. For example, sludge 116 from an oil storage tank may include sand, scale, rinsate, rocks, tar, heavy metals and a significant portion of oil of the kind that had been stored in the tank 101 and that became mixed in or adhered to the sludge 116.

In operation, water or some other liquid 120 that may include a separating agent solvent 110, de-emulsifier or other additive may be pumped from pump 106 to tank 101 by way of input pipe 104. End 107 of input pipe 104 may direct a flow of liquid 120 in a circular motion (shown in FIG. 1 by arrow x) so that liquid 120 actively circulates or rotates within tank 101. Preferably, a rotational flow of liquid 120 within tank 101 will create a centrifugal force within tank 101, where such force is exerted at a level that includes the boundary where liquid 120 is contiguous to sludge 116. Liquid 120 may be heated to temperatures of approximately 70° C., though higher temperatures are possible as may be beneficial to increase a rate of dissolution or de-emulsification of product 118 as may be held in sludge. Liquid 120 may be drawn out of tank 101 by way of drain 104 and end 105. Liquid 120 may be directed back to pump 106 where it may be heated by heating unit 108 and pumped back into tank 101 by way of input pipe 102, thereby establishing a closed circulation of liquid 120 between tank 101 and pump 106. After an extended period during which sludge 116 is subject to the temperature and physical chemical effect of liquid 120 and to the physical chemical effect of liquid 120 with additive 110, some or all of product 118 as had been mixed with, adhered to or become a part of sludge 116, may separate and float to a level above liquid 120. Product 118 that rose above liquid 120 may be skimmed or pumped out of tank 101 to collection tank 112. Liquid 120 may then be drained from tank 101 and may, in some embodiments be directed for re-use in tank 103. The volume of sludge 116 may be removed or collected.

In some embodiments, a set of one or more holes may be drilled or bored into a wall of tank 101 to accommodate pipe 104 and drain 102. In some embodiments, pipe 102 may be at an elevation that is close to a top level of sludge 116 so that a force of liquid 120 entering tank 101 from pump 106 is exerted proximate to an upper level of sludge 116. An orifice of drain 102 may preferably be located away from an orifice of pipe 104, such as diametrically opposed to such pipe 104, so that a flow of water returning to pump 106 by way of drain 102, does not interfere with a desired motion or force of liquid 120 pumped into tank 101 by way of pipe 104. In some embodiments, end 107 of pipe 104 may point in a direction of the desired flow or motion of liquid 120 in tank 101, and end 105 of drain 102 may point in an opposite direction so as to retain a velocity of liquid entering pump 106. Other directions of ends 105 and 107 are possible as may be desired to alter a direction or flow of liquid 120 in tank 101. For example, in some embodiments, end 107 may be directed downward towards a bottom of tank 101, or at some other angle, to create both a downward and circular flow of liquid 120. In some embodiments, input pipe 104 may also serve as a drain to remove liquid 120 from tank 101 at the end of a separation process or at some other time. In some embodiments, some or all of liquid 120 may be piped or pumped into another tank 103 while still warm so preserve heat and economize on the energy required to operate the system. Other components of system 100, such as pump 106, heater108 and additive unit 110 may likewise be moved to other tanks 103 in a tank storage area.

In some embodiments, pump 106 may be or include any suitable industrial pump capable of pumping volumes of 300 cu.mt. per hour. In some embodiments, pump 106 may also pressurize an inside of tank 101 to between 3 and 5 atmosphere as such pressure may be beneficial in increasing a rate of dissolving or emulsification of product 118 in liquid 120. Other volumes and pressure levels are possible.

Heating unit 108 may be or include a heating element that that may heat liquid 120 directly, or may heat pipe-enclosed oil or other solutions that may pass through pipe 104 or some other vessel carrying liquid 120. Steam generated heat may also be used.

In some embodiments, an orifice for pipe 104 or drain 102 may be cut into a wall of tank 101 and may be suitable for sealing upon a completion of a separation process in accordance with an embodiment of the invention.

In some embodiments, an increase in a material such as an additive 110, or an increase in for example Orthosilicic acid (H4SiO4) as may result from a partially distillated volume of water may be added to or produced in a liquid 120 before or during a processing of pumping liquid 120 into tank 101, or at some other period. Additive 110 may be or include a solvent, de-emulsifier or other compound as may be beneficial in increasing a rate of dissolution of product 118 from sludge 116. Abrasives such as crystals, sand or other particles may also be added to liquid 120 to increase a rate of abrasion of congealed sludge 116.

In some embodiments, a process of pumping, agitation and dissolution of sludge 116 may continue for hours, several days or more, as may be determined by a depth or volume of sludge 116, age or consistency of sludge 116, ambient temperatures and other factors. In some embodiments, a float and sink monitor with a radio transmitter may be inserted into tank 101 as a gauge to measure the dissolution or level of sludge 116 as the process is undertaken. Other measuring devices may be used.

In some embodiments, product 118 may be skimmed or separated from liquid at one or more points during the pumping process. In some embodiments, skimming of product 118 may be undertaken at the end of the process or at some time afterward when some or all of product 118 has separated from liquid 120. In some embodiments, separated product 118 may be collected in collection tank 112.

In some embodiments, a desired level or volume of liquid 120 that may be added to tank 101 may be determined by a level of pipe 102, drain 104 and a level or height of skimming outlet 122. Other volumes of liquid 120 may be used so that separated product rises above liquid to a level that facilitates skimming or removal from outlet 122

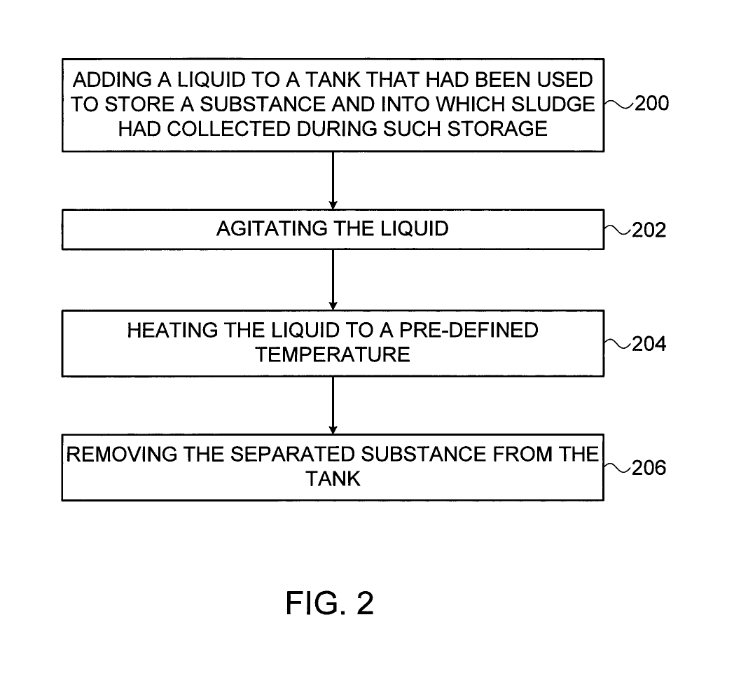

Reference is made to FIG. 2, a flow diagram of a method in accordance with an embodiment of the invention. In some embodiments, a method for separating a product or other substance from sludge collected in a tank during a period of storage of the substance in the tank, may, as in block 200, include adding a liquid to the tank that had been used to store the substance and into which the sludge had collected during such storage. The method may include, as in block 202, agitating the liquid added to the tank while such liquid is above the sludge. In block 204, the liquid may be heated to a pre-defined temperature. In block 206 the substance separated from the sludge may be removed from the tank as it collects above a level of the liquid and the sludge. A volume of the liquid added to the tank may be calculated so that a level of the product floating on top of the liquid may reach an outlet for draining the collected substance from the tank.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for separating a substance from sludge collected in a tank during a period of storage of said substance in said tank, comprising:
adding a liquid to said tank, said tank suitable to store said substance;
agitating said liquid in said tank, said liquid agitated above a level of said sludge collected in said tank during said storage of said substance in said tank;
heating said liquid to a pre-defined temperature; and
removing from said tank said substance separated from said sludge.

2. The method as in claim 1, wherein said adding comprises pumping said liquid into said tank for a period exceeding 24 hours.

3. The method as in claim 1, wherein said agitating comprises establishing a rotational movement of said liquid in said tank.

4. The method as in claim 3, wherein said adding comprises adding said liquid in a direction of said rotational movement.

5. The method as in claim 1, wherein said pre-defined temperature is between 70 and 140 degrees Celsius.

6. The method as in claim 1, wherein said removing comprises removing said substance suspended above said liquid, said liquid suspended above said sludge.

7. The method as in claim 1, wherein said adding comprises adding said liquid comprising water and orthosilicic acid.

8. The method as in claim 1, comprising removing said liquid from said tank and introducing said liquid into another tank, while retaining said pre-defined temperature of said liquid.

9. The method as in claim 1, wherein said adding comprises adding a volume of said liquid as is sufficient to raise a level of said substance to a pre-defined level.

10. A system for separating a substance from sludge in a tank, comprising:
a liquid, said liquid suitable to separate a substance from sludge in a tank, said tank used to store said substance, and said sludge having settled in said tank during a period of storage of said substance in said tank;
an agitator suitable to agitate said liquid above said sludge in said tank; and
an outlet to remove said separated substance from a level above said liquid in said tank.

11. The system as in claim 10, wherein said agitator comprises a pump, said pump suitable to pump said liquid into said tank and generate a rotational movement of said liquid in said tank.

12. The system as in claim 10, comprising a heater to heat said liquid to a pre-defined temperature.

13. The system as in claim 10, comprising a drain, said drain to remove said liquid from said tank and direct said liquid to said pump.

14. The system as in claim 10, comprising a curved inlet to direct said liquid in said tank in a rotational movement.

15. The system as in claim 10, wherein said agitator is removably attached to said tank.

16. The system as in claim 10, comprising a collection unit to store said separated substance.
